(19) United States
(12) Patent Application Publication
(10) Pub. No.: US 2026/0351836 A1
(43) Pub. Date: Nov. 5, 2026

(54) ELECTRONIC PACKAGE AND MANUFACTURING METHOD THEREOF

(71) Applicant: SILICONWARE PRECISION INDUSTRIES CO., LTD., Taichung City (TW)

(72) Inventors: Shin-Hao CHENG, Taichung City (TW); Chih-Yu LIN, Taichung City (TW); Chao-Ya YANG, Taichung City (TW); Chia-Chen CHIAO, Taichung City (TW); Ming-Chih CHANG, Taichung City (TW); Chun-Sheng CHANG, Taichung City (TW)

(73) Assignee: SILICONWARE PRECISION INDUSTRIES CO., LTD., Taichung City (TW)

(21) Appl. No.: 19/411,978

(22) Filed: Dec. 8, 2025

(30) Foreign Application Priority Data
Apr. 30, 2025 (TW) 114116402

(51) Int. Cl. H01Q 1/22; H01Q 1/52

(52) U.S. Cl. CPC H01Q 1/2283; H01Q 1/526

(57) ABSTRACT

An electronic package and a method of manufacturing the electronic package are provided. At least one electronic component is disposed on a substrate. An antenna module is disposed on the substrate and covers the periphery of the electronic component. The antenna module includes an insulating cover, a cavity, an isolation layer, a conductive via, and an antenna structure. The insulating cover covers the periphery of the electronic component. The electronic component is within the cavity. The isolation layer is formed on wall surfaces of the cavity. The conductive via is formed in the insulating cover and penetrates through the insulating cover. The antenna structure is formed on the insulating cover and sequentially electrically connected to the conductive via and the substrate. The isolation layer is between the antenna structure and the electronic component. Thereby, well electromagnetic interference protection, isolation, or shielding can be provided for the electronic component.

### BACKGROUND

### 1. Technical Field

The present disclosure relates to a manufacturing technology of an electronic package, and more particularly, to an electronic package with an antenna module and a method of manufacturing the same.

### 2. Description of Related Art

In recent years, the rapid development of portable electronic products has pushed related products toward high density, high performance, and slim, compact designs. To meet these demands, various multi-functional integrated packaging configurations have been developed to satisfy the requirements of slim, compact, and high-density electronic products. For example, wireless communication technology is now widely applied in various consumer electronic products for receiving or transmitting wireless signals, and the patch antenna is widely used in wireless communication modules of electronic products such as cell phones, personal digital assistants (PDAs) because of its small size, low weight, and ease of manufacturing.

Moreover, in system-in-package (SiP) modules that incorporate radio-frequency (RF) functionality, electromagnetic interference (EMI) isolation is typically implemented using iron covers or metal coatings to provide EMI protection, isolation, or shielding to the electronic components. However, if an SiP module includes only an antenna structure without an isolation layer, it cannot adequately protect, isolate, or shield the electronic components from EMI.

FIG. 1 is a schematic perspective view of a conventional system-in-package module 1. As shown in FIG. 1, the system-in-package module 1 may be a wireless communication module and includes a substrate 10, a plurality of electronic components 11, an antenna structure 12, and a packaging material 13. The electronic components 11 are disposed on the substrate 10 and are electrically connected to the substrate 10. The antenna structure 12 is planar and has an antenna body 120 and a wire 121, wherein the antenna body 120 is electrically connected to the electronic component 11 via the wire 121, and the packaging material 13 covers the electronic components 11 and part of the wire 121.

However, since the system-in-package module 1 includes only the antenna structure 12 without an isolation layer, it is unable to provide effective EMI protection, isolation, or shielding for the electronic components 11.

Therefore, how to overcome any of the aforementioned issues in the prior art has become an urgent problem to be solved.

### SUMMARY

In view of the aforementioned shortcomings of the prior art, the present disclosure provides an electronic package, which comprises: a substrate; an electronic component disposed on the substrate; and an antenna module disposed on the substrate and covering the electronic component, wherein the antenna module comprises an insulating cover, a first cavity, a first isolation layer, a first conductive via, and a first antenna structure, the insulating cover covers a periphery of the electronic component, the electronic component is located within the first cavity, the first isolation layer is formed on wall surfaces of the first cavity, the first conductive via is formed in the insulating cover and penetrates through the insulating cover, the first antenna structure is formed on the insulating cover and electrically connected to the first conductive via and the substrate, and the first isolation layer is between the first antenna structure and the electronic component.

The present disclosure further provides a method of manufacturing an electronic package, and the method comprises: disposing an electronic component on a substrate; and disposing an antenna module on the substrate to cover the electronic component, wherein the antenna module comprises an insulating cover, a first cavity, a first isolation layer, a first conductive via, and a first antenna structure, the insulating cover covers a periphery of the electronic component, the electronic component is located within the first cavity, the first isolation layer is formed on wall surfaces of the first cavity, the first conductive via is formed in the insulating cover and penetrates through the insulating cover, the first antenna structure is formed on the insulating cover and electrically connected to the first conductive via and the substrate, and the first isolation layer is between the first antenna structure and the electronic component.

In the aforementioned electronic package and method, the insulating cover is a glass isolation cover, and the first conductive via is a through-glass via containing a conductive material.

In the aforementioned electronic package and method, the antenna module further comprises a second cavity, a plurality of the electronic components are respectively located within the first cavity and the second cavity, and the first isolation layer is between the first antenna structure and the electronic component located within the first cavity.

In the aforementioned electronic package and method, the antenna module further comprises a second isolation layer formed on wall surfaces of the second cavity, and the second isolation layer is between the first antenna structure and the electronic component located within the second cavity.

In the aforementioned electronic package and method, the antenna module further comprises a second conductive via and a second antenna structure, the second conductive via is formed in the insulating cover and penetrates through the insulating cover, and the second antenna structure is formed on the insulating cover and electrically connected to the second conductive via and the substrate.

In the aforementioned electronic package and method, the first antenna structure is an antenna array constituted by a plurality of antenna blocks, and the first isolation layer is between the antenna array and the electronic component.

In the aforementioned electronic package and method, the antenna module further comprises a second cavity, the first antenna structure is an antenna array constituted by a plurality of antenna blocks, and a plurality of the electronic components are respectively located within the first cavity and the second cavity.

In the aforementioned electronic package and method, the antenna module further comprises an insulating substrate and an antenna signal enhancement structure, the insulating substrate is formed on the insulating cover and the first antenna structure, and the antenna signal enhancement structure is formed on the insulating substrate.

In the aforementioned electronic package and method, the first antenna structure is a first antenna array constituted by a plurality of first antenna blocks, the antenna signal enhancement structure is a second antenna array constituted by a plurality of second antenna blocks, and the plurality of first antenna blocks correspond to the plurality of second antenna blocks.

In the aforementioned electronic package and method, the first antenna structure is separated from the antenna signal enhancement structure by a distance, and the distance is one-half of a wavelength of an antenna signal of the first antenna structure, or plus or minus 10% of one-half of the wavelength.

It can be seen from the above that, in the electronic package and the manufacturing method thereof of the present disclosure, the integration of the first isolation layer (and/or the second isolation layer), the first conductive via (and/or the second conductive via), and the first antenna structure (and/or the second antenna structure) effectively provides excellent electromagnetic interference (EMI) protection, isolation, or shielding for the electronic component. At the same time, the present disclosure overcomes the drawback of the conventional system-in-package modules that include only an antenna structure (without an isolation layer) and thus fail to provide adequate EMI protection, isolation, or shielding.

Moreover, the first isolation layer of the antenna module of the present disclosure can provide conformal shielding for the first antenna structure and the electronic component so as to effectively isolate/shield the signal interference or the electromagnetic interference between the first antenna structure and the electronic component. Alternatively, the first isolation layer and the second isolation layer of the antenna module of the present disclosure can provide compartmental shielding for the first antenna structure (and/or the second antenna structure) and the plurality of electronic components, thereby effectively isolating/shielding the signal interference or the electromagnetic interference between the first antenna structure (and/or the second antenna structure) and the plurality of electronic components.

In addition, the antenna signal enhancement structure (such as the second antenna array) of the antenna module of the present disclosure can be formed on the insulating substrate, so that the antenna signal of the first antenna structure (such as the first antenna array) is effectively enhanced by the antenna signal enhancement structure.

### BRIEF DESCRIPTION OF THE DRAWINGS

FIG. 1 is a schematic perspective view of a conventional system-in-package module.

FIG. 2A to FIG. 2F are schematic cross-sectional views illustrating a main manufacturing method of an antenna module according to the present disclosure.

FIG. 3A and FIG. 3B are, respectively, a schematic top view and a schematic cross-sectional view of an electronic package according to a first embodiment of the present disclosure.

FIG. 4A and FIG. 4B are, respectively, a schematic top view and a schematic cross-sectional view of an electronic package according to a second embodiment of the present disclosure.

FIG. 5A and FIG. 5B are, respectively, a schematic top view and a schematic cross-sectional view of an electronic package according to a third embodiment of the present disclosure.

FIG. 6A and FIG. 6B are, respectively, a schematic top view and a schematic cross-sectional view of an electronic package according to a fourth embodiment of the present disclosure.

FIG. 7A and FIG. 7B are, respectively, a schematic top view and a schematic cross-sectional view of an electronic package according to a fifth embodiment of the present disclosure.

FIG. 8A and FIG. 8B are, respectively, a schematic top view and a schematic cross-sectional view of an electronic package according to a sixth embodiment of the present disclosure.

FIG. 9A and FIG. 9B are, respectively, a schematic top view and a schematic cross-sectional view of an electronic package according to a seventh embodiment of the present disclosure.

FIG. 10A and FIG. 10B are, respectively, a schematic top view and a schematic cross-sectional view of an electronic package according to an eighth embodiment of the present disclosure.

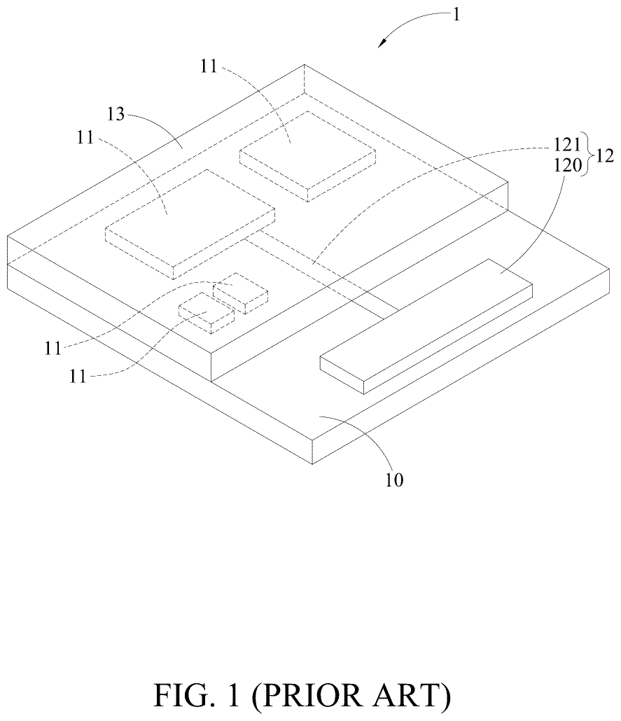

### DETAILED DESCRIPTION

The following describes the implementation of the present disclosure with examples. Those skilled in the art can easily understand other advantages and effects of the present disclosure from the contents disclosed in this specification.

It should be understood that, the structures, ratios, sizes, and the like in the accompanying figures are used for illustrative purposes to facilitate the perusal and comprehension of the contents disclosed in the present specification by one skilled in the art, rather than to limit the conditions for practicing the present disclosure. Any modification of the structures, alteration of the ratio relationships, or adjustment of the sizes without affecting the possible effects and achievable proposes should still be deemed as falling within the scope defined by the technical contents disclosed in the present specification. Meanwhile, terms such as “on,” “under,” “a,” “one,” “two,” “first,” “second,” “third,” and the like are for clear explanation rather than limiting the practicable scope of the present disclosure, and thus, alterations or adjustments of the relative relationships thereof without essentially altering the technical contents should still be considered in the practicable scope of the present disclosure.

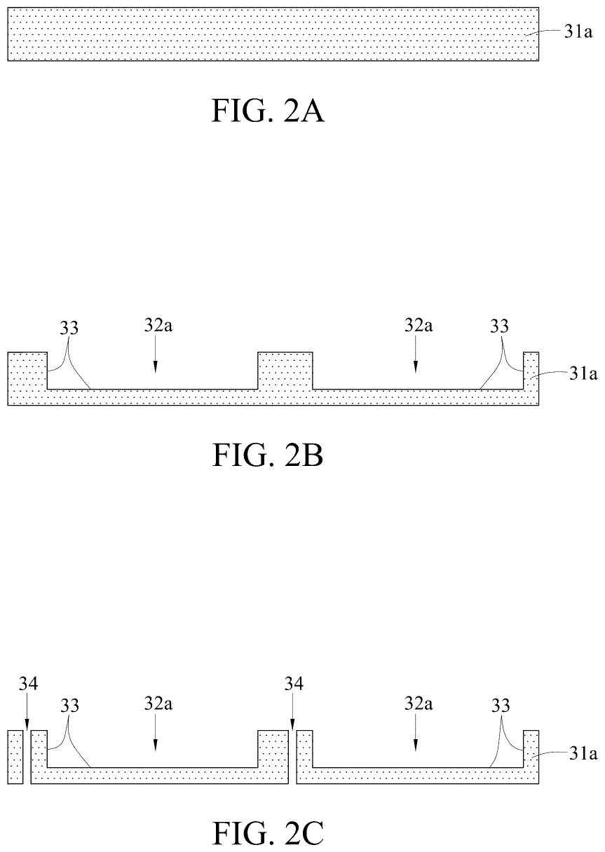

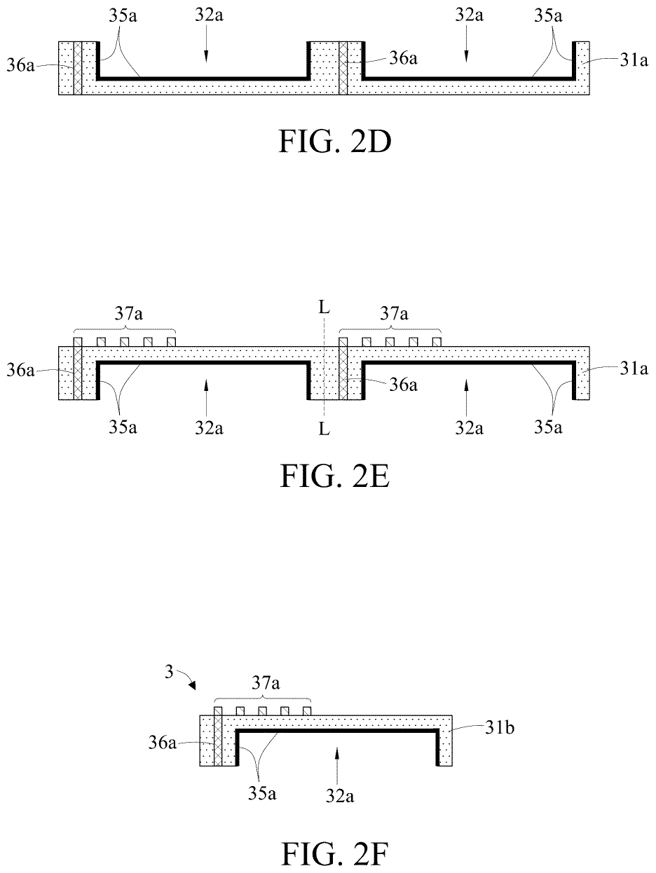

FIG. 2A to FIG. 2F are schematic cross-sectional views illustrating a main manufacturing method of an antenna module 3 according to the present disclosure. Meanwhile, the term “at least one” described in the present disclosure means one or more than one (such as one, two, or three), and the term “a plurality of” means two or more than two (such as two, three, four, ten, or more than ten).

As shown in FIG. 2A to FIG. 2C, an insulating substrate 31a is first provided. A plurality of (e.g., at least two) first cavities 32a are formed in the insulating substrate 31a by etching. A plurality of (e.g., at least two) through-holes 34 are formed in the insulating substrate 31a by various through-hole manufacturing methods (such as a laser drilling method).

In one embodiment, the insulating substrate 31a may be a glass substrate. The first cavity 32a may be an isolation cavity, a clearance/recess cavity, an etched clearance/recess area, or an accommodation space. Within the first cavity 32a, walls or wall surfaces 33 having a U-shape or a [symbol] -shape configuration are provided.

As shown in FIG. 2D, a plurality of (e.g., at least two) first isolation layers 35a are formed on the wall surfaces 33 of the plurality of first cavities 32a of the insulating substrate 31a (e.g., a glass substrate) by a sputtering method (e.g., a metal sputtering method). Then, by a metallization process or a filling process, conductive material is formed or filled in the plurality of through-holes 34 to form a plurality of (e.g., at least two) first conductive vias 36a (e.g., first conductive through-vias), wherein the plurality of first conductive vias 36a do not contact the plurality of first isolation layers 35a.

In one embodiment, the first isolation layer 35a may be a signal isolation layer, a signal shielding layer, an electromagnetic shielding layer, or an electromagnetic interference (EMI) isolation layer made of a metal material. The first conductive via 36a may be a through-glass via (TGV) containing a conductive material (e.g., a metal material).

As shown in FIG. 2E, the entire structure in FIG. 2D is turned upside down to form a plurality of (e.g., at least two) first antenna structures 37a on a surface (e.g., a top surface) of the insulating substrate 31a (e.g., a glass substrate). One end of the first antenna structure 37a is electrically connected to the first conductive via 36a.

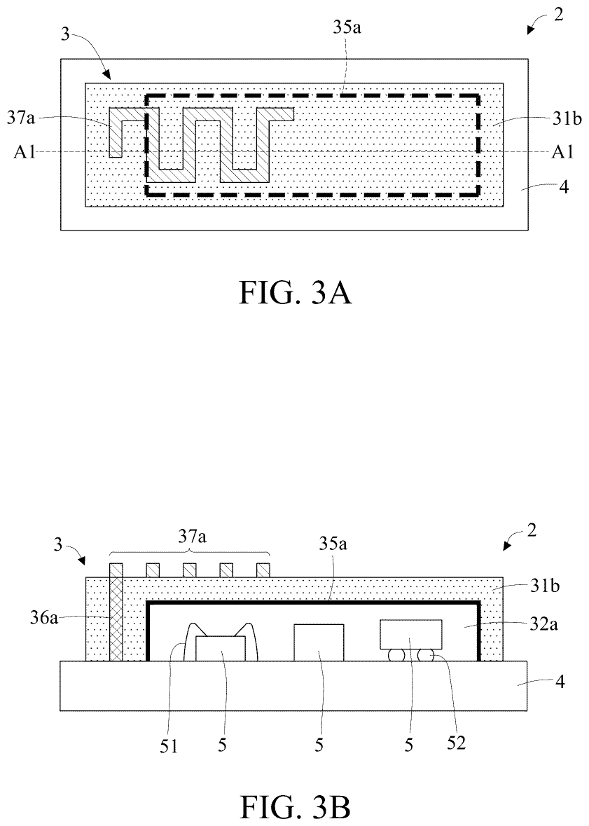

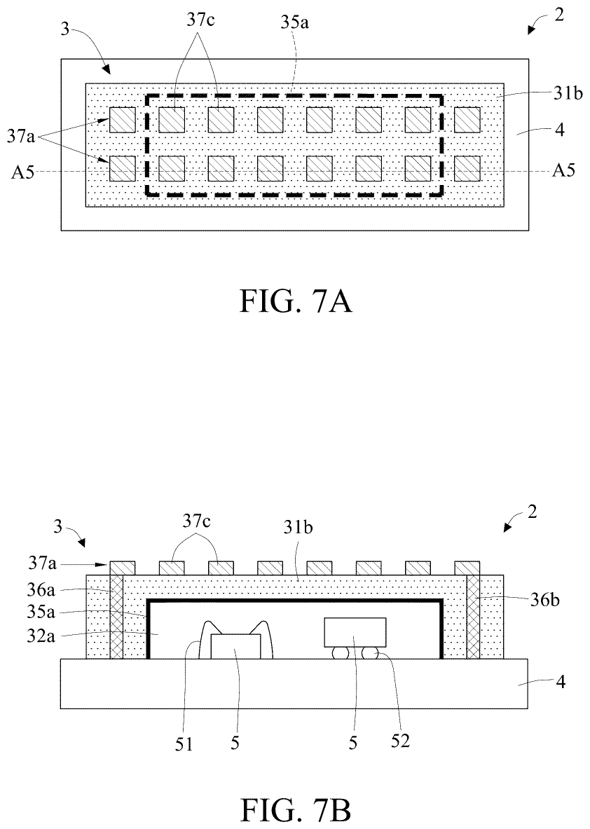

In one embodiment, the shape of the first antenna structure 37a may be meandering/serpentine (as shown in FIG. 3A), regular, or irregular; alternatively, the first antenna structure 37a may be an antenna array (as shown in FIG. 7A).

As shown in FIG. 2F, according to the division line L in FIG. 2E, the entire structure in FIG. 2E is singulated by various cutting methods, thereby obtaining a plurality of (e.g., at least two) antenna modules 3. Each of the antenna modules 3 comprises an insulating cover 31b, a first cavity 32a, a first isolation layer 35a, a first conductive via 36a, and a first antenna structure 37a. The insulating cover 31b may be a glass isolation cover.

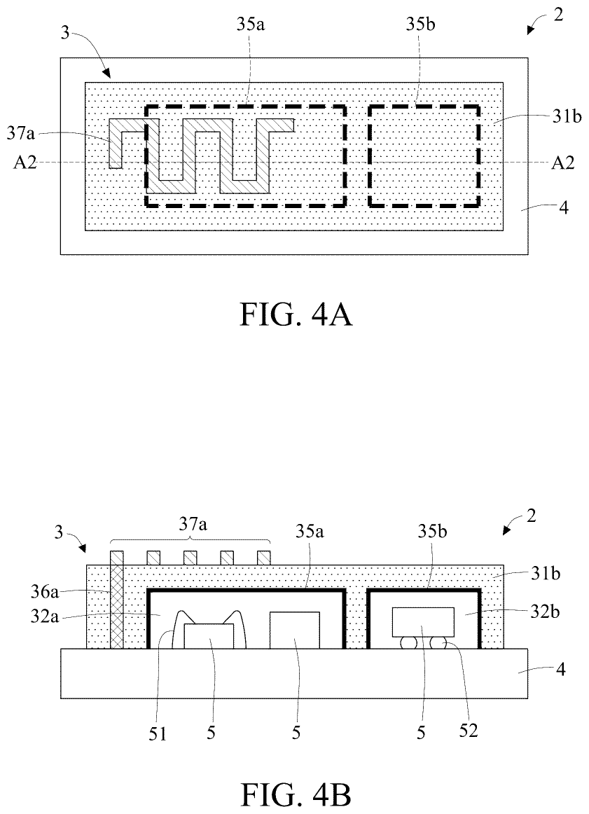

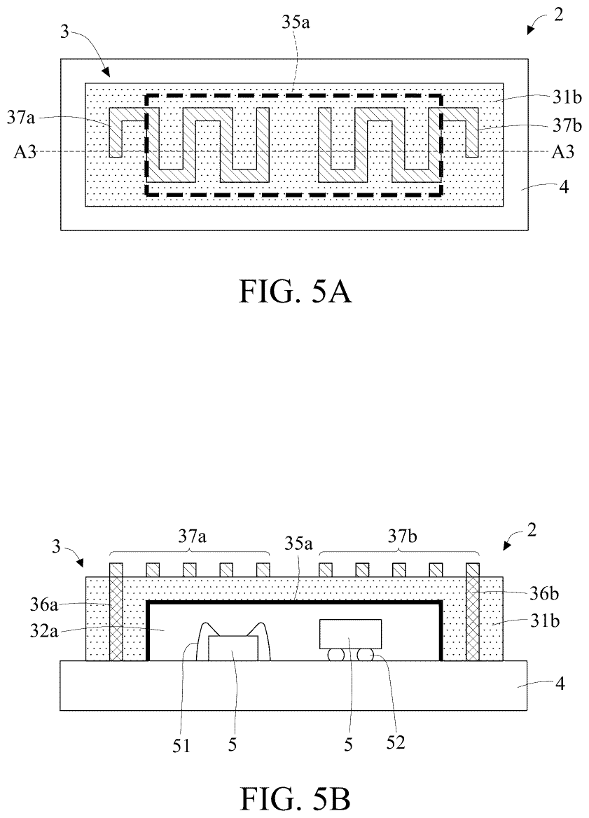

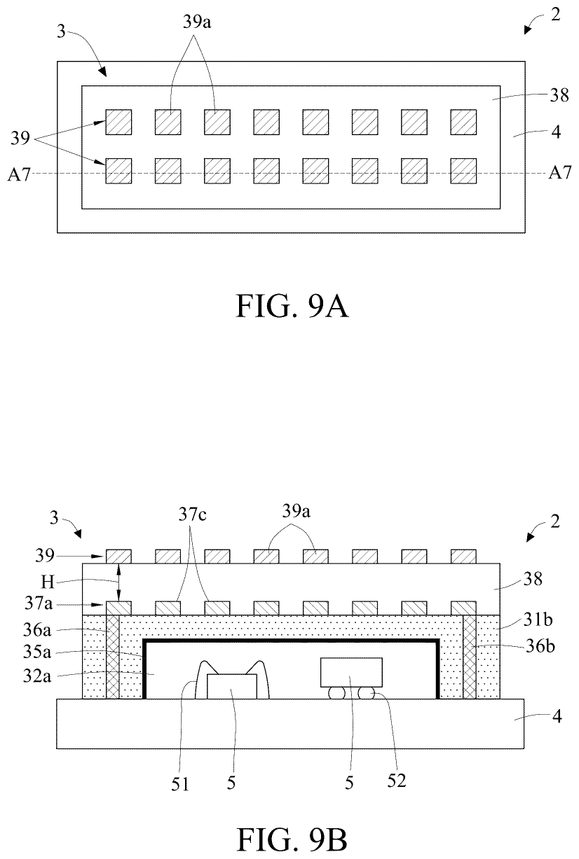

In other embodiments, the antenna module 3 further comprises a second cavity 32b and a second isolation layer 35b (refer to FIG. 4A and FIG. 4B), or further comprises a second conductive via 36b (e.g., second conductive through-via) and a second antenna structure 37b (refer to FIG. 5A and FIG. 5B), or further comprises an insulating substrate 38 and an antenna signal enhancement structure 39 (refer to FIG. 9A and FIG. 9B). The fabrication processes for the second cavity 32b, the second isolation layer 35b, the second conductive via 36b, and the second antenna structure 37b are the same as those described for the first cavity 32a, the first isolation layer 35a, the first conductive via 36a, and the first antenna structure 37a, respectively, and thus will not be repeated.

FIG. 3A and FIG. 3B are, respectively, a schematic top view and a schematic cross-sectional view of an electronic package 2 according to a first embodiment of the present disclosure, with FIG. 3B being a schematic cross-sectional view taken along line A1 in the electronic package 2 shown in FIG. 3A.

As shown in FIG. 3A and FIG. 3B, the electronic package 2 mainly comprises a substrate 4, at least one (or a plurality of) electronic component 5, and an antenna module 3 (refer to FIG. 2F). The antenna module 3 may include an insulating cover 31b, a first cavity 32a, a first isolation layer 35a, a first conductive via 36a, and a first antenna structure 37a, wherein the first antenna structure 37a is a single antenna.

In the manufacturing method of the electronic package 2, a substrate 4 can be first provided, and at least one (or a plurality of) electronic component 5 is disposed on the surface (e.g., the top surface) of the substrate 4. The electronic component 5 is electrically connected to the substrate 4 via bonding wires 51 or solder balls 52; alternatively, the electronic component 5 may be directly in contact with or directly electrically connected to the substrate 4. Then, the antenna module 3 is disposed on the surface (e.g., the top surface) of the substrate 4, so that the insulating cover 31b (e.g., a glass isolation cover) of the antenna module 3 covers the periphery (e.g., the top and surroundings) of all the electronic components 5, such that all the electronic components 5, the bonding wires 51, and/or the solder balls 52 are located within the first cavity 32a of the antenna module 3.

In one embodiment, the first isolation layer 35a of the antenna module 3 may be formed on the wall surfaces 33 of the first cavity 32a. The first antenna structure 37a may be formed on the surface (e.g., the top surface) of the insulating cover 31b. The first isolation layer 35a may be disposed between the first antenna structure 37a and the electronic component 5 located within the first cavity 32a, or between the first conductive via 36a and the electronic component 5 located within the first cavity 32a, so that the first isolation layer 35a can provide conformal shielding for the first antenna structure 37a and the electronic component 5, thereby effectively isolating/shielding the signal interference or the electromagnetic interference between the first antenna structure 37a and the electronic component 5.

In one embodiment, the first conductive via 36a may be formed in the insulating cover 31b to penetrate through the insulating cover 31b. The shape of the first antenna structure 37a may be meandering/serpentine. One end of the first antenna structure 37a is electrically connected to the first conductive via 36a. The first antenna structure 37a may be fed with an antenna signal (such as a radio-frequency signal) or be electrically connected to the substrate 4 via the first conductive via 36a.

In one embodiment, the substrate 4 may be a circuit substrate, a package substrate, a circuit board, a circuit structure, a carrier board, or an interposer. The electronic component 5 may be an active component, a passive component, or a combination of the active component and the passive component. For example, the active component is a semiconductor chip or a semiconductor component, and the passive component is a resistor, a capacitor, or an inductor.

FIG. 4A and FIG. 4B are, respectively, a schematic top view and a schematic cross-sectional view of an electronic package 2 according to a second embodiment of the present disclosure, with FIG. 4B being a schematic cross-sectional view taken along line A2 in the electronic package 2 shown in FIG. 4A. The electronic package 2 in FIG. 4A and FIG. 4B is similar to that shown in FIG. 3A and FIG. 3B; therefore, only the main differences in the electronic package 2 of FIG. 4A and FIG. 4B are described below.

As shown in FIG. 4A and FIG. 4B, the antenna module 3 of the electronic package 2 may further comprise a second cavity 32b and a second isolation layer 35b. The first antenna structure 37a of the antenna module 3 is a single antenna. A plurality of electronic components 5 are respectively located in the first cavity 32a and the second cavity 32b.

In one embodiment, the first isolation layer 35a may be disposed between the first antenna structure 37a and the electronic component 5 located within the first cavity 32a. The second isolation layer 35b may be formed on the wall surfaces of the second cavity 32b and disposed between the first antenna structure 37a and the electronic component 5 located within the second cavity 32b. Thus, the first isolation layer 35a and the second isolation layer 35b can provide compartmental shielding for the first antenna structure 37a and the plurality of electronic components 5, thereby effectively isolating/shielding the signal interference or the electromagnetic interference between the first antenna structure 37a and the plurality of electronic components 5.

In one embodiment, the second cavity 32b may be an isolation cavity, a clearance/recess cavity, an etched clearance/recess area, or an accommodation space. The second cavity 32b has walls or wall surfaces configured in a U-shape or a [symbol] -shape (resembling the wall surfaces 33 shown in FIG. 2B). The second isolation layer 35b may be a signal isolation layer, a signal shielding layer, an electromagnetic shielding layer, or an EMI isolation layer made of a metal material.

FIG. 5A and FIG. 5B are, respectively, a schematic top view and a schematic cross-sectional view of an electronic package 2 according to a third embodiment of the present disclosure, with FIG. 5B being a schematic cross-sectional view taken along line A3 in the electronic package 2 shown in FIG. 5A. The electronic package 2 in FIG. 5A and FIG. 5B is similar to that shown in FIG. 3A and FIG. 3B; therefore, only the main differences in the electronic package 2 of FIG. 5A and FIG. 5B are described below.

As shown in FIG. 5A and FIG. 5B, the antenna module 3 of the electronic package 2 may further comprise a second conductive via 36b and a second antenna structure 37b. The first antenna structure 37a and the second antenna structure 37b together constitute a dual antenna.

In one embodiment, both the first conductive via 36a and the second conductive via 36b may be formed in the insulating cover 31b so as to penetrate through the insulating cover 31b. The first conductive via 36a and the second conductive via 36b are respectively located outside (e.g., on the left side and the right side) of the first isolation layer 35a. The first cavity 32a, the first isolation layer 35a, and the electronic component 5 are all located between the first conductive via 36a and the second conductive via 36b. The first conductive via 36a and the second conductive via 36b do not contact the first isolation layer 35a.

In one embodiment, the first antenna structure 37a and the second antenna structure 37b may be respectively formed at different positions on the surface (e.g., the top surface) of the insulating cover 31b. The first antenna structure 37a may be sequentially electrically connected to the first conductive via 36a and the substrate 4. The second antenna structure 37b may be sequentially electrically connected to the second conductive via 36b and the substrate 4.

In one embodiment, the first isolation layer 35a may be disposed between the first antenna structure 37a, the second antenna structure 37b, and the electronic component 5 located within the first cavity 32a, so that the first isolation layer 35a can provide conformal shielding for the first antenna structure 37a, the second antenna structure 37b, and the electronic component 5, thereby effectively isolating/shielding the signal interference or the electromagnetic interference between the first antenna structure 37a, the second antenna structure 37b, and the electronic component 5.

In one embodiment, the second conductive via 36b may be a through-glass via (TGV) containing a conductive material (e.g., a metal material). The shape of the second antenna structure 37b may be meandering/serpentine (as shown in FIG. 5A), regular, or irregular.

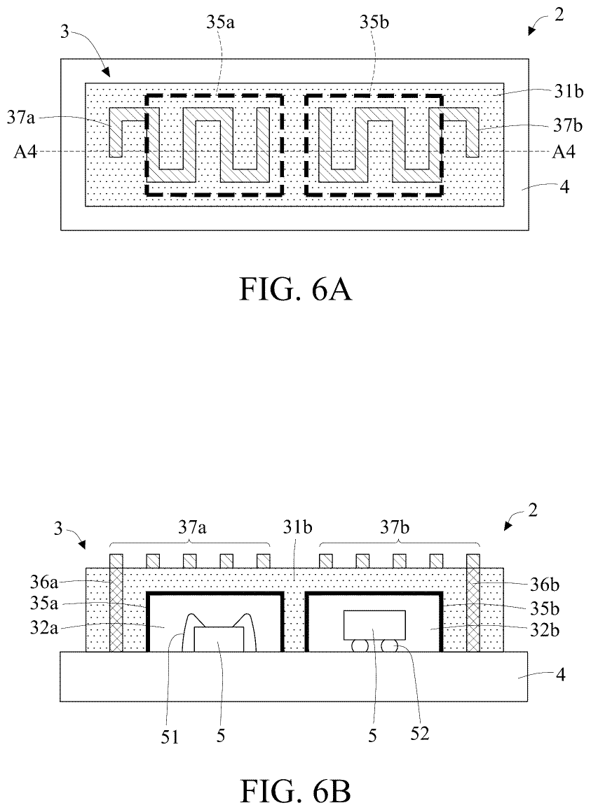

FIG. 6A and FIG. 6B are, respectively, a schematic top view and a schematic cross-sectional view of an electronic package 2 according to a fourth embodiment of the present disclosure, with FIG. 6B being a schematic cross-sectional view taken along line A4 in the electronic package 2 shown in FIG. 6A. The electronic package 2 in FIG. 6A and FIG. 6B is similar to that shown in FIG. 5A and FIG. 5B; therefore, only the main differences in the electronic package 2 of FIG. 6A and FIG. 6B are described below.

As shown in FIG. 6A and FIG. 6B, the antenna module 3 of the electronic package 2 may further comprise a second cavity 32b and a second isolation layer 35b. The first antenna structure 37a and the second antenna structure 37b together constitute a dual antenna. A plurality of electronic components 5 are respectively located in the first cavity 32a and the second cavity 32b.

In one embodiment, the first isolation layer 35a may be disposed between the first antenna structure 37a and the electronic component 5 located within the first cavity 32a. The second isolation layer 35b may be formed on the wall surfaces of the second cavity 32b and disposed between the second antenna structure 37b and the electronic component 5 located within the second cavity 32b. Thus, the first isolation layer 35a and the second isolation layer 35b can provide compartmental shielding for the first antenna structure 37a, the second antenna structure 37b, and the plurality of electronic components 5, thereby effectively isolating/shielding the signal interference or the electromagnetic interference between the first antenna structure 37a, the second antenna structure 37b, and the plurality of electronic components 5.

In one embodiment, the first cavity 32a, the first isolation layer 35a, the second cavity 32b, the second isolation layer 35b, and the electronic component 5 are all located between the first conductive via 36a and the second conductive via 36b. The first conductive via 36a and the second conductive via 36b do not contact the first isolation layer 35a and the second isolation layer 35b.

FIG. 7A and FIG. 7B are, respectively, a schematic top view and a schematic cross-sectional view of an electronic package 2 according to a fifth embodiment of the present disclosure, with FIG. 7B being a schematic cross-sectional view taken along line A5 in the electronic package 2 shown in FIG. 7A. The electronic package 2 in FIG. 7A and FIG. 7B is similar to that shown in FIG. 5A and FIG. 5B; therefore, only the main differences in the electronic package 2 of FIG. 7A and FIG. 7B are described below.

As shown in FIG. 7A and FIG. 7B, the first antenna structure 37a of the antenna module 3 of the electronic package 2 is an antenna array constituted by a plurality of antenna blocks 37c. The antenna blocks 37c located at different positions (e.g., on the left side and the right side) of the first antenna structure 37a (such as the antenna array) are electrically connected to the first conductive via 36a and the second conductive via 36b, respectively, such that the first antenna structure 37a may be fed with an antenna signal (such as a radio-frequency signal) or be electrically connected to the substrate 4 via the first conductive via 36a and the second conductive via 36b.

In one embodiment, the first isolation layer 35a may be disposed between the first antenna structure 37a (such as the antenna array) and the electronic component 5 located within the first cavity 32a, so that the first isolation layer 35a can provide conformal shielding for the first antenna structure 37a and the electronic component 5, thereby effectively isolating/shielding the signal interference or the electromagnetic interference between the first antenna structure 37a and the electronic component 5.

In one embodiment, a plurality of antenna blocks 37c of the first antenna structure 37a (such as the antenna array) may be arranged in at least one row or several rows. The distances between the plurality of antenna blocks 37c or the areas of the plurality of antenna blocks 37c may be the same or different. The first isolation layer 35a may be disposed between the plurality of antenna blocks 37c of the first antenna structure 37a and at least one (or a plurality of) electronic component 5.

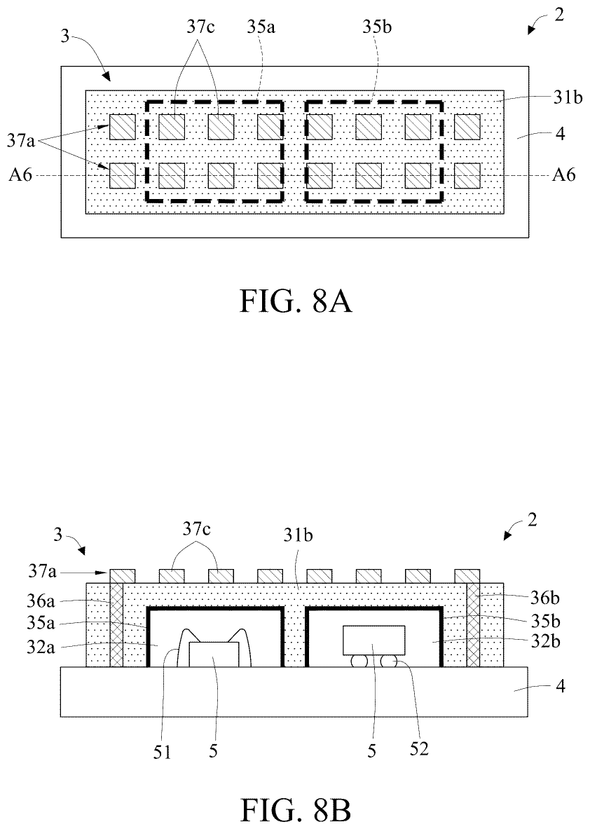

FIG. 8A and FIG. 8B are, respectively, a schematic top view and a schematic cross-sectional view of an electronic package 2 according to a sixth embodiment of the present disclosure, with FIG. 8B being a schematic cross-sectional view taken along line A6 in the electronic package 2 shown in FIG. 8A. The electronic package 2 in FIG. 8A and FIG. 8B is similar to that shown in FIG. 7A and FIG. 7B; therefore, only the main differences in the electronic package 2 of FIG. 8A and FIG. 8B are described below.

As shown in FIG. 8A and FIG. 8B, the antenna module 3 of the electronic package 2 may further comprise a second cavity 32b and a second isolation layer 35b. The first antenna structure 37a may be an antenna array constituted by a plurality of antenna blocks 37c. A plurality of electronic components 5 are respectively located in the first cavity 32a and the second cavity 32b.

In one embodiment, the first isolation layer 35a may be disposed between the first antenna structure 37a (such as the antenna array) and the electronic component 5 located within the first cavity 32a. The second isolation layer 35b may be formed on the wall surfaces of the second cavity 32b and disposed between the first antenna structure 37a (such as the antenna array) and the electronic component 5 located within the second cavity 32b. Thus, the first isolation layer 35a and the second isolation layer 35b can provide compartmental shielding for the first antenna structure 37a (such as the antenna array) and the plurality of electronic components 5, thereby effectively isolating/shielding the signal interference or the electromagnetic interference between the first antenna structure 37a (such as the antenna array) and the plurality of electronic components 5.

In one embodiment, the first cavity 32a, the first isolation layer 35a, the second cavity 32b, the second isolation layer 35b, and the electronic component 5 are all located between the first conductive via 36a and the second conductive via 36b. The first conductive via 36a and the second conductive via 36b do not contact the first isolation layer 35a and the second isolation layer 35b.

FIG. 9A and FIG. 9B are, respectively, a schematic top view and a schematic cross-sectional view of an electronic package 2 according to a seventh embodiment of the present disclosure, with FIG. 9B being a schematic cross-sectional view taken along line A7 in the electronic package 2 shown in FIG. 9A. The electronic package 2 in FIG. 9A and FIG. 9B is similar to that shown in FIG. 7A and FIG. 7B; therefore, only the main differences in the electronic package 2 of FIG. 9A and FIG. 9B are described below.

As shown in FIG. 9A and FIG. 9B, the antenna module 3 of the electronic package 2 may further comprise an insulating substrate 38 and an antenna signal enhancement structure 39. The insulating substrate 38 may be formed on the insulating cover 31b and the first antenna structure 37a (e.g., above the insulating cover 31b and the first antenna structure 37a), and the antenna signal enhancement structure 39 may be formed on the insulating substrate 38, so that the antenna signal of the first antenna structure 37a is effectively enhanced (strengthened) by the antenna signal enhancement structure 39.

In one embodiment, the first antenna structure 37a may be an antenna array (such as a first antenna array) constituted by a plurality of antenna blocks 37c (such as the first antenna blocks). The antenna signal enhancement structure 39 may be an antenna array (such as a second antenna array) constituted by a plurality of antenna blocks 39a (such as the second antenna blocks). The plurality of antenna blocks 37c (such as the first antenna blocks) may correspond to the plurality of antenna blocks 39a (such as the second antenna blocks).

In one embodiment, a plurality of antenna blocks 39a of the antenna signal enhancement structure 39 (such as the second antenna array) may be arranged in at least one row or several rows. The distances between the plurality of antenna blocks 39a or the areas of the plurality of antenna blocks 39a may be the same with or different from that of the plurality of antenna blocks 37c. The first isolation layer 35a is disposed between the plurality of antenna blocks 37c of the first antenna structure 37a (such as the first antenna array) and at least one (or a plurality of) electronic component 5.

In one embodiment, the first antenna structure 37a (the antenna blocks 37c) and the antenna signal enhancement structure 39 (the antenna blocks 39a) may be separated by a distance H, wherein the distance H may be equal to one-half of the wavelength (i.e., ½λ) of the antenna signal of the first antenna structure 37a, or within a range of plus or minus 10% of one-half of the wavelength (i.e., ½λ±10%).

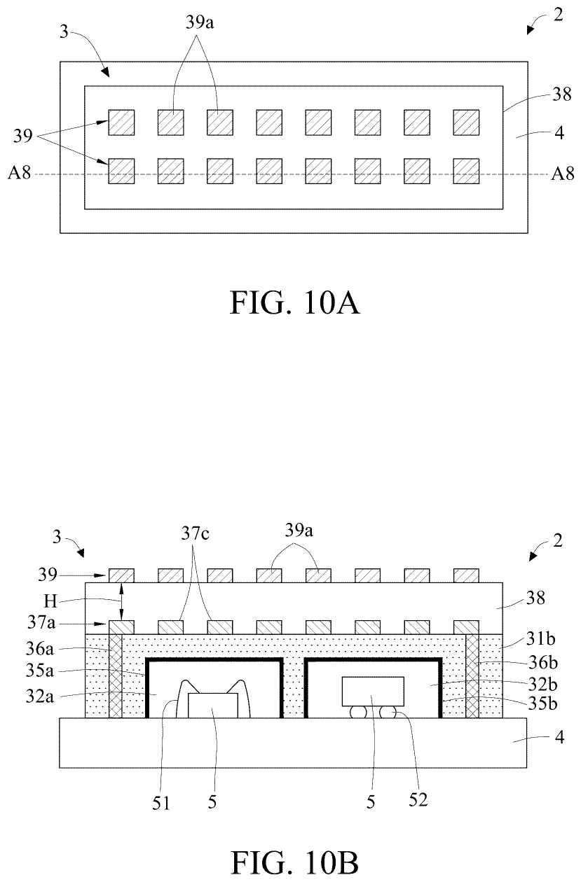

FIG. 10A and FIG. 10B are, respectively, a schematic top view and a schematic cross-sectional view of an electronic package 2 according to an eighth embodiment of the present disclosure, with FIG. 10B being a schematic cross-sectional view taken along line A8 in the electronic package 2 shown in FIG. 10A. The electronic package 2 in FIG. 10A and FIG. 10B is similar to that shown in FIG. 9A and FIG. 9B; therefore, only the main differences in the electronic package 2 of FIG. 10A and FIG. 10B are described below.

As shown in FIG. 10A and FIG. 10B, the antenna module 3 of the electronic package 2 may further comprise a second cavity 32b and a second isolation layer 35b. The first antenna structure 37a may be an antenna array (such as the first antenna array) constituted by a plurality of antenna blocks 37c. The antenna signal enhancement structure 39 may be an antenna array (such as the second antenna array) constituted by a plurality of antenna blocks 39a. A plurality of electronic components 5 are respectively located in the first cavity 32a and the second cavity 32b.

In one embodiment, the first isolation layer 35a may be disposed between the first antenna structure 37a (such as the first antenna array) and the electronic component 5 located within the first cavity 32a. The second isolation layer 35b may be formed on the wall surfaces of the second cavity 32b and disposed between the first antenna structure 37a (such as the first antenna array) and the electronic component 5 located within the second cavity 32b. The first antenna structure 37a may be disposed between the first isolation layer 35a, the second isolation layer 35b, and the antenna signal enhancement structure 39. Thus, the first isolation layer 35a and the second isolation layer 35b can provide compartmental shielding for the first antenna structure 37a (such as the first antenna array) and the plurality of electronic components 5, thereby effectively isolating/shielding the signal interference or the electromagnetic interference between the first antenna structure 37a (such as the first antenna array) and the plurality of electronic components 5.

In summary, the electronic package 2 and the manufacturing method thereof of the present disclosure have at least the following features, advantages, or technical effects.
1. The electronic package 2 of the present disclosure can effectively integrate the first isolation layer 35a (and/or the second isolation layer 35b), the first conductive via 36a (and/or the second conductive via 36b), and the first antenna structure 37a (and/or the second antenna structure 37b) to provide excellent EMI protection, isolation, or shielding for the electronic component 5. At the same time, the present disclosure overcomes the drawback of the conventional system-in-package modules that include only an antenna structure (without an isolation layer) and thus fail to provide adequate EMI protection, isolation, or shielding.
2. The electronic package 2 of the present disclosure represents a new configuration/architecture for system-in-package products, which makes effective use of the first isolation layer 35a (and/or the second isolation layer 35b), the first conductive via 36a (and/or the second conductive via 36b), and the first antenna structure 37a (and/or the second antenna structure 37b), thereby achieving both EMI shielding and integrated antenna functionality.
3. The first isolation layer 35a of the antenna module 3 of the present disclosure can provide conformal shielding for the first antenna structure 37a and the electronic component 5 to effectively isolate/shield the signal interference or the electromagnetic interference between the first antenna structure 37a and the electronic component 5.
4. The first isolation layer 35a and the second isolation layer 35b of the antenna module 3 of the present disclosure can provide compartmental shielding for the first antenna structure 37a (and/or the second antenna structure 37b) and the plurality of electronic components 5, thereby effectively isolating/shielding the signal interference or the electromagnetic interference between the first antenna structure 37a (and/or the second antenna structure 37b) and the plurality of electronic components 5.
5. The first isolation layer 35a of the antenna module 3 of the present disclosure can provide conformal shielding for the antenna array of the first antenna structure 37a and the electronic component 5, so as to effectively isolate/shield the signal interference or the electromagnetic interference between the antenna array of the first antenna structure 37a and the electronic component 5.
6. The insulating substrate 38 of the antenna module 3 of the present disclosure can be formed on the insulating cover 31b and the first antenna structure 37a, and the antenna signal enhancement structure 39 can be formed on the insulating substrate 38, so that the antenna signal of the first antenna structure 37a is effectively enhanced (strengthened) by the antenna signal enhancement structure 39.

The above embodiments are provided for illustrating the principles of the present disclosure and its technical effect, and should not be construed as to limit the present disclosure in any way. The above embodiments can be modified by one of ordinary skill in the art without departing from the spirit and scope of the present disclosure. Therefore, the scope claimed of the present disclosure should be defined by the following claims.

What is claimed is:

1. An electronic package, comprising:
a substrate;
an electronic component disposed on the substrate; and
an antenna module disposed on the substrate and covering the electronic component,
wherein the antenna module comprises an insulating cover, a first cavity, a first isolation layer, a first conductive via, and a first antenna structure, the insulating cover covers a periphery of the electronic component, the electronic component is located within the first cavity, the first isolation layer is formed on wall surfaces of the first cavity, the first conductive via is formed in the insulating cover and penetrates through the insulating cover, the first antenna structure is formed on the insulating cover and electrically connected to the first conductive via and the substrate, and the first isolation layer is between the first antenna structure and the electronic component.

2. The electronic package of claim 1, wherein the insulating cover is a glass isolation cover, and the first conductive via is a through-glass via containing a conductive material.

3. The electronic package of claim 1, wherein the antenna module further comprises a second cavity, a plurality of the electronic components are respectively located within the first cavity and the second cavity, and the first isolation layer is between the first antenna structure and the electronic component located within the first cavity.

4. The electronic package of claim 3, wherein the antenna module further comprises a second isolation layer formed on wall surfaces of the second cavity, and the second isolation layer is between the first antenna structure and the electronic component located within the second cavity.

5. The electronic package of claim 1, wherein the antenna module further comprises a second conductive via and a second antenna structure, the second conductive via is formed in the insulating cover and penetrates through the insulating cover, and the second antenna structure is formed on the insulating cover and electrically connected to the second conductive via and the substrate.

6. The electronic package of claim 1, wherein the first antenna structure is an antenna array constituted by a plurality of antenna blocks, and the first isolation layer is between the antenna array and the electronic component.

7. The electronic package of claim 1, wherein the antenna module further comprises a second cavity, the first antenna structure is an antenna array constituted by a plurality of antenna blocks, and a plurality of the electronic components are respectively located within the first cavity and the second cavity.

8. The electronic package of claim 1, wherein the antenna module further comprises an insulating substrate and an antenna signal enhancement structure, the insulating substrate is formed on the insulating cover and the first antenna structure, and the antenna signal enhancement structure is formed on the insulating substrate.

9. The electronic package of claim 8, wherein the first antenna structure is a first antenna array constituted by a plurality of first antenna blocks, the antenna signal enhancement structure is a second antenna array constituted by a plurality of second antenna blocks, and the plurality of first antenna blocks correspond to the plurality of second antenna blocks.

10. The electronic package of claim 8, wherein the first antenna structure is separated from the antenna signal enhancement structure by a distance, and the distance is one-half of a wavelength of an antenna signal of the first antenna structure, or plus or minus 10% of one-half of the wavelength.

11. A method of manufacturing an electronic package, comprising:
disposing an electronic component on a substrate; and
disposing an antenna module on the substrate to cover the electronic component,
wherein the antenna module comprises an insulating cover, a first cavity, a first isolation layer, a first conductive via, and a first antenna structure, the insulating cover covers a periphery of the electronic component, the electronic component is located within the first cavity, the first isolation layer is formed on wall surfaces of the first cavity, the first conductive via is formed in the insulating cover and penetrates through the insulating cover, the first antenna structure is formed on the insulating cover and electrically connected to the first conductive via and the substrate, and the first isolation layer is between the first antenna structure and the electronic component.

12. The method of claim 11, wherein the insulating cover is a glass isolation cover, and the first conductive via is a through-glass via containing a conductive material.

13. The method of claim 11, wherein the antenna module further comprises a second cavity, a plurality of the electronic components are respectively located within the first cavity and the second cavity, and the first isolation layer is between the first antenna structure and the electronic component located within the first cavity.

14. The method of claim 13, wherein the antenna module further comprises a second isolation layer formed on wall surfaces of the second cavity, and the second isolation layer is between the first antenna structure and the electronic component located within the second cavity.

15. The method of claim 11, wherein the antenna module further comprises a second conductive via and a second antenna structure, the second conductive via is formed in the insulating cover and penetrates through the insulating cover, and the second antenna structure is formed on the insulating cover and electrically connected to the second conductive via and the substrate.

16. The method of claim 11, wherein the first antenna structure is an antenna array constituted by a plurality of antenna blocks, and the first isolation layer is between the antenna array and the electronic component.

17. The method of claim 11, wherein the antenna module further comprises a second cavity, the first antenna structure is an antenna array constituted by a plurality of antenna blocks, and a plurality of the electronic components are respectively located within the first cavity and the second cavity.

18. The method of claim 11, wherein the antenna module further comprises an insulating substrate and an antenna signal enhancement structure, the insulating substrate is formed on the insulating cover and the first antenna structure, and the antenna signal enhancement structure is formed on the insulating substrate.

19. The method of claim 18, wherein the first antenna structure is a first antenna array constituted by a plurality of first antenna blocks, the antenna signal enhancement structure is a second antenna array constituted by a plurality of second antenna blocks, and the plurality of first antenna blocks correspond to the plurality of second antenna blocks.

20. The method of claim 18, wherein the first antenna structure is separated from the antenna signal enhancement structure by a distance, and the distance is one-half of a wavelength of an antenna signal of the first antenna structure, or plus or minus 10% of one-half of the wavelength.
